(19) United States
(12) Patent Application Publication
(10) Pub. No.: US 2009/0030966 A1
(43) Pub. Date: Jan. 29, 2009

(54) METHOD AND A NETWORK FOR COMMUNICATING DATA VIA A COMPUTER NETWORK

(75) Inventors: Christian Morck, Rungsted Kyst (DK); Lars Halver, The Caribbean (TT); Svenne Krap, Copenhagen (DK)

Correspondence Address: HARNESS, DICKEY & PIERCE, P.L.C., P.O. BOX 8910, RESTON, VA, 20195, US

(73) Assignee: INFLOW APS, FREDERIKSBERG C. (DK)

(21) Appl. No.: 11/665,858

(22) PCT Filed: Oct. 21, 2005
(86) PCT No.: PCT/DK05/00683

§ 371 Date: Feb. 20, 2008

Related U.S. Application Data
(60) Provisional application No. 60/620,332, filed on Oct. 21, 2004.

(51) Int. Cl. G06F 15/16

(52) U.S. Cl. 709/201

(57) ABSTRACT

A method and a computer network for two computers to communicate, where one computer generates an instruction set for the second computer to carry out, the instruction set including an instruction for reloading the instruction set, and at least one instruction set comprising an instruction for the second computer to request further data from the first computer, a third computer, or a website

### FIELD OF THE INVENTION

The present invention relates to a method and a computer network for communicating data via a computer network, where a data communication channel is established between two computers. The communication of the data takes place via this communication channel. The method and the network of the present invention are particularly suited for remote presentation of data, e.g. in case a salesperson wishes to present a product to a potential customer, or in case of remote education.

The present invention further relates to a method for remotely presenting a website to a person while maintaining control of the presentation.

### BACKGROUND OF THE INVENTION

Presentation systems where one person (e.g. a salesperson or a teacher) demonstrates something on another person's (e.g. a potential customer or a student) computer are known. However, when using such prior art systems it is necessary that the potential customer/student installs special software on his/her computer. It may even be necessary to activate an executable file. In particular in case of a sales session this constitutes a barrier because it requires the potential customer to do something actively and to install software which he/she may not want permanently. Furthermore, many companies have a software policy which does not allow employees to install software or activate executable files. The network systems of some companies are even set up to remove executable files attached to e-mails, or to ensure that it is not possible for the recipient to activate them. It is therefore difficult to gain access to potential customers under these circumstances.

### SUMMARY OF THE INVENTION

It is an object of the present invention to provide a method for communicating data via a computer network, which allows one person to remotely demonstrate or present data to another person without requiring the other person to install additional software on his/her computer.

It is a further object of the present invention to provide a method as defined above, which does not require that the other person activates an executable file.

It is an even further object of the invention to provide a computer network which is suitable for performing the steps of the method of the invention.

According to a first aspect of the present invention the above and other objects are fulfilled by providing a method for communicating data via a computer network, the method comprising the steps of:
1. establishing a data communication channel between a first computer and a second computer,
2. the first computer generating an instruction set, said instruction set comprising an instruction for the second computer to reload said instruction set when the instruction set has been received by the second computer,
3. the first computer communicating the instruction set to the second computer using the data communication channel,
4. the first computer modifying the instruction set, the modified instruction set comprising an instruction for the second computer to reload the instruction set when the instruction set has been received by the second computer,
5. the second computer carrying out the instructions of the instruction set, thereby receiving/reloading the modified instruction set, and
   repeating steps 4 and 5 until the first and/or the second computer terminates the process, wherein at least one of the instruction sets further comprises an instruction for the second computer to request further data and/or information from the first computer, a website and/or from a third computer, the method further comprising the steps of:
the second computer requesting said further data and/or information, and
the second computer receiving said further data and/or information.

According to a second aspect of the present invention the above and other objects are fulfilled by providing a computer network comprising:
a first computer and a second computer, each being capable of establishing a data communication channel, so as to create a data communication channel between said first computer and said second computer,
means for generating an instruction set in the first computer, said instruction set comprising an instruction for the second computer to reload said instruction set when the instruction set has been received by the second computer,
means for communicating the instruction set to the second computer using the communication channel,
means for modifying the instruction set in the first computer, the modified instruction set comprising an instruction for the second computer to reload the instruction set when the instruction set has been received by the second computer,
means for carrying out the instructions of the instruction set by the second computer, and
   means for terminating the process on the occasion of the first and/or the second computer, wherein at least one of the instruction sets further comprises an instruction for the second computer to request further data a nd/or information from the first computer, a website and/or from a third computer.

The first computer is preferably used by a person who wishes to present or demonstrate data, e.g. a salesperson or a teacher, and the second computer is preferably used by a person to whom the data is to be presented or demonstrated, e.g. a potential customer or a student. The first computer may function as a server or be connected to a server. This server preferably hosts the website via which the first computer and the second computer are connected. The first computer and the second computer are preferably positioned remotely, i.e. with a distance which makes it impossible for users of the two computers to talk directly.

The computer network may comprise further computers, preferably similar to the second computer, thereby allowing a user of the first computer to communicate the same data/information to a number of other computers. This is particularly useful in case of an educational system where a teacher/lecturer using the first computer may communicate with a number of students.

The communication between the computers may be via a website, which may be controlled by one of the computers and which may be facilitating the communication by the other of the computers actually logging on to the website or contacting it in order to initiate communication.

The instruction sets generated by the first computer always comprise an instruction to reload the instruction set when the instruction set has been received by the second computer. Thus, each time an instruction set has been loaded/reloaded, the second computer will immediately start a new reload of the instruction set. Thereby a recursive action or an endless loop has been started which can only be stopped again by an active action by the first and/or the second computer. Such an act may be one of the computers closing one or more programs running on the respective computer, or one of the computers disconnecting the data communication channel. Alternatively, the first computer may decide that the session is over and subsequently modify the instruction set in such a way that it does not comprise an instruction for the second computer to reload the instruction set. Thereby the endless loop will be broken since no further reload will be carried out by the second computer. Alternatively, the reload instruction may comprise a delay instruction instructing the second computer to wait for a specified time from the instruction set has been received before reloading the instruction set. The delay time may, e.g., be one second or half a second, thereby avoiding that the second computer reloads several times each second, and by far the major part of the reloaded instruction sets contains only the reload instruction.

It should be understood that when it is described above that ‘the first computer’ and ‘the second computer’ are performing certain actions, this may include an active action by a user using the respective computer, e.g. activating one or more keys on a keyboard, using a mouse or activating a computer program.

As described above each instruction set generated by the first computer comprises an instruction for the second computer to reload the instruction set when it has been received. The instruction set may additionally comprise other instructions for the second computer. The first computer is constantly checking whether or not changes have happened which require the second computer to do something in order to keep the session going as planned by a user using the first computer. If changes have happened, the first computer will modify the instruction set to include one or more instructions for the second computer to perform one or more corresponding actions. The subsequent instruction set will be modified in such a way that it does not comprise these instructions because the second computer will already have received them and will therefore already be in the act of carrying out the instructions, or maybe it has already finished carrying out the instructions. In case no changes have happened the first computer will not modify the instruction set, and the next instruction set will therefore typically only comprise the instruction to reload the instruction set.

The communicated data preferably comprise the instruction sets and any other additional data which is to be communicated to the second computer. This will be further described below.

It is an advantage of the present invention that each instruction set comprises an instruction for the second computer to reload the instruction set, thereby creating a self generating loop of reloads, because it is thereby ensured that the communication between the first computer and the second computer is maintained until one of the computers actively terminates it. Furthermore, the self generating loop of reloads makes it possible for a user of the first computer to control a presentation at the second computer without the need for downloading special software or activating an executable file at the second computer.

In a preferred embodiment the first and the second computer communicate via a browser interface. In this case the browser window at the second computer is preferably divided into two frames. One of the frames is ‘visible’, i.e. it contains any information to be delivered to the second computer, such as visual or audible data. The other frame is ‘invisible’, i.e. the user of the second computer does not perceive the information contained therein. The ‘invisible’ frame contains the instruction sets, and each time a reload instruction is received, this frame is reloaded while the ‘visible’ frame is not affected. Furthermore, in case any other instruction is comprised in the instruction set, the ‘invisible’ frame takes care that the instruction is carried out. However, carrying out an instruction may have an impact on the ‘visible’ frame, e.g. by showing a new slide, playing a video or an audio file, etc. Thus, the second computer keeps reloading the ‘invisible’ frame, thereby constantly requesting whether or not any changes have happened. This is often referred to as a ‘client pull’ operation.

The ‘visible’ frame may comprise a window in which a live video streaming of a person using the first computer is shown.

The third computer may e.g. be a server hosting a website containing information which the user of the first computer wishes to show to the user of the second computer. Thus, the instruction set comprises an instruction for the second computer to navigate to this specific website.

When the further data and/or information is to be requested from the first computer, the corresponding instruction may be an instruction to request a new slide, flash file, audio file, video clip, PowerPoint presentation, HTML document, MHTML document, HTM document, PDF document, JPG document, etc. from the first computer. This may be initiated by the user of the first computer changing the slide of a slide show or activating a relevant file, etc., and the first computer then knows that the second computer also needs to carry out a similar action, and it therefore generates one or more corresponding instructions for the second computer to request the relevant data and/or information. The instruction set is subsequently modified accordingly, and the second computer will receive the instruction(s) with the next reload.

The method may further comprise the step of the second computer processing said requested data and/or information in a predetermined manner. This may include displaying a slide, playing an audio file, showing a video clip, going to a specific website, etc. The ‘predetermined manner’ may have been defined by an instruction comprised in at least one of the instruction sets. Thus, the instruction set may, e.g., comprise an instruction to request a video file from the first computer and an instruction to play the video file, displaying it on a monitor connected to the second computer.

Thus, the further data and/or information may comprise at least one of audible data, visible data, and interactive data. Interactive data may include data which require the user of the second computer to do something, e.g. activate one or more keyboard or mouse keys, activate a link, fill in one or more data fields, answer one or more questions, etc. In case the user of the second computer needs to answer one or more questions, the answers may be collected in a Q&A database.

In case the further data is positioned at the first computer, the method may further comprise the step of the first computer preparing the further data. Thus, the first computer may prepare the next slide, video clip, audio file, etc. It may, e.g., be necessary to adapt a ‘standard’ slide to the specific customer or the specific situation. The preparation of the further data may be caused by one or more actions performed by a person using the first computer, e.g. the user selecting a new slide, activating a specific file, entering a website, etc.

In one embodiment the method may further comprise the steps of:
the first computer establishing a link to an external website,
the first computer creating a modified version of said external website,
the first computer generating an instruction set comprising an instruction for the second computer to request the modified external website, and
the second computer downloading the modified external website.

The step of creating a modified version of the external website may comprise removing any active link present in the external website, thereby making the modified external website, which is displayed at the second computer, completely passive in the sense that it is not possible for the user of the second computer to control the navigation. This will be described in more detail below with reference to FIG. 2.

At least one of the instruction sets may further comprise an instruction to perform one or more local actions at the second computer. In this case the method may further comprise the step of the second computer performing said one or more local actions. The one or more local actions may e.g. be printing a document at a printer connected to the second computer, saving a document at the second computer, and/or adjusting the size of a visible frame on a monitor of the second computer. In this embodiment it is possible for a user of the first computer to remotely control local actions at the second computer.

The step of establishing a data communication channel may comprise entering a password via the second computer. In this case a special website is preferably created at a server, and as long as the session between the first computer and the second computer is ongoing this website is reserved for the communication between these two computers. The special website may be adapted to the specific occasion, e.g. by greeting the user of the second computer by stating his or her name.

Alternatively or additionally, the step of establishing a data communication channel may comprise the step of the second computer activating an active link or a button on an introduction website. The remarks set forth above are equally applicable here.

Alternatively or additionally, the step of establishing a data communication channel may be performed in the following manner. A person using the second computer enters the website. The website comprises a communication possibility, e.g. a chat function and/or a video stream from a webcam showing a person using the first computer and possibly a corresponding audio stream allowing the person using the second computer to listen to the person using the first computer. Thus, the person using the second computer may immediately communicate directly with a person using the first computer. During this initial communication the person using the first computer may create an active link on the website, and when the person using the second computer activates this link, the data communication channel is established. Alternatively, the data communication channel may be established merely by the person using the second computer entering the website and commencing the communication with the person using the first computer as described above. Preferably, the person using the first computer during a chat function and/or being shown in a live video streaming is also the person who the person using the second computer is going to talk to later in the process.

Preferably, the person using the second computer is contacted very quickly after the data communication channel has been established. This may, e.g. be achieved by means of Internet Protocol (IP) telephony incorporated in the system. In this case the person using the second computer can be contacted within a few seconds.

In a preferred embodiment the instruction to reload the instruction set is carried out by emulating an activation of a refresh button of the second computer. Thereby a functionality which is already present in the second computer is used for carrying out the reload of the instruction set, thereby avoiding the need for downloading special programs or activating executable files in order for the second computer to be able to carry out the reload. Furthermore, by using this particular functionality it is avoided that the second computer produces ‘clicking noises’ at each reload. Such ‘clicking noises’ are very annoying and may cause a user of the second computer to end the session, thereby preventing the user of the first computer (e.g. a salesperson) from delivering all the desired data or information to the user of the second computer.

The step of modifying the instruction set may comprise updating an entry in a database. Such an entry may, e.g., comprise information relating to a status of the ongoing session, information relating to which instructions have been passed on to the second computer, any changes in the first computer which may give rise to the first computer generating an instruction for the second computer other than a reload instruction, etc. The changes mentioned above may, e.g., be the user of the first computer selecting a new slide or activating a specific file or a specific link as described above.

The method may further comprise the step of establishing a separate communication channel between a person using the first computer and a person using the second computer. In this case the steps of the method are preferably performed while the person using the first computer and the person using the second computer communicate via the separate communication channel. The separate communication channel is preferably a telephone connection, such as a connection via a public switched telephone network (PSTN), via a cell phone network, or via Internet Protocol (IP) telephony. In this case the user of the first computer and the user of the second computer may speak to each other during the session, thereby giving the user of the first computer the possibility of explaining the presentations occurring at the second computer to the user of the second computer. Furthermore, this gives a person using the first computer a possibility to customize the presentation to a person using the second computer, since a parallel telephone conversation may give the person using the first computer an indication of needs and interests of the person using the second computer, and he/she may therefore choose the course of actions according to these needs and interests. Alternatively the separate communication channel may be any other suitable kind of communication channel, such as a separate communication channel of the computer network or a different computer network. In this case the user of the first computer and the user of the second computer may communicate in writing, e.g. via a chat forum, e-mails or the like.

In one embodiment where the user of the first computer is a salesperson and the user of the second computer is a potential customer, the method of the present invention is preferably performed as follows.

The salesperson places a telephone call to the customer and asks him or her to open a specific website. The customer opens the website, and the salesperson creates a session between the salesperson and the customer, indicating the name and company of the customer. To this end a server, to which the salesperson is connected, creates a post in a database and returns a unique password or pin code to the salesperson. The salesperson communicates this password to the customer over the telephone, and the customer enters the password via the website. During this the server continually requests whether or not the customer is online. As soon as the customer has entered the password, the server notices that the customer is online and updates the database accordingly. Thereby a communication channel has been established between the salesperson and the customer via the website. The monitor at the customer's computer shows a ‘welcoming slide’, preferably a personal slide stating the name and/or the company of the customer.

The salesperson can now see that the customer is online and the session can begin. During the complete session the customers computer is continually checking the server to see if any changes have happened which require corresponding changes in the customers computer. This is done in the following manner. When the customer opens the website and enters the password, the customers computer receives an instruction set comprising an instruction to reload the instruction set. The customers computer therefore keeps reloading the instruction to reload until some changes have happened. The customers computer will not perceive these reloads since they will cause no visible or audible changes at the customer's computer.

When the salesperson wishes to present a new slide to the customer the following happens. The salesperson selects the slide. The server then updates the database to indicate that the slide in question has been selected. The instruction set is then modified to include an instruction for the customers computer to request the new slide. Thus, the next time the customers computer reloads the instruction set, the reloaded instruction set will include an instruction to request the new slide as well as an instruction to reload the instruction set. Accordingly, the customers computer will request the new slide and the slide will be presented to the customer. As soon as the instruction to request the new slide has been communicated to the customers computer, the server again updates the database in order to ensure that the customers computer does not yet again receive the instruction to request the new slide with the subsequent reload.

In case the salesperson wishes to print a document at a printer connected to the customer's computer, the salesperson indicates this, and the server accordingly updates the database. Thereby the instruction set is modified to include an instruction to print the document, and the next time the customers computer reloads the instruction set it will receive this instruction, and will then send the document to the printer in accordance with the instruction.

When the salesperson has finished his/her presentation, he/she can end the session. The server notices this and updates the database accordingly. Alternatively the customer may end the session, e.g. by closing the browser running on the customer's computer.

### BRIEF DESCRIPTION OF THE DRAWINGS

FIG. 1 is a flowchart illustrating the method of the present invention, and

FIG. 2 is a flowchart illustrating the presentation of a specific website to a controlee.

FIG. 3 illustrates a flow diagram of a particular manner of illustrating a website.

### DETAILED DESCRIPTION OF THE DRAWINGS

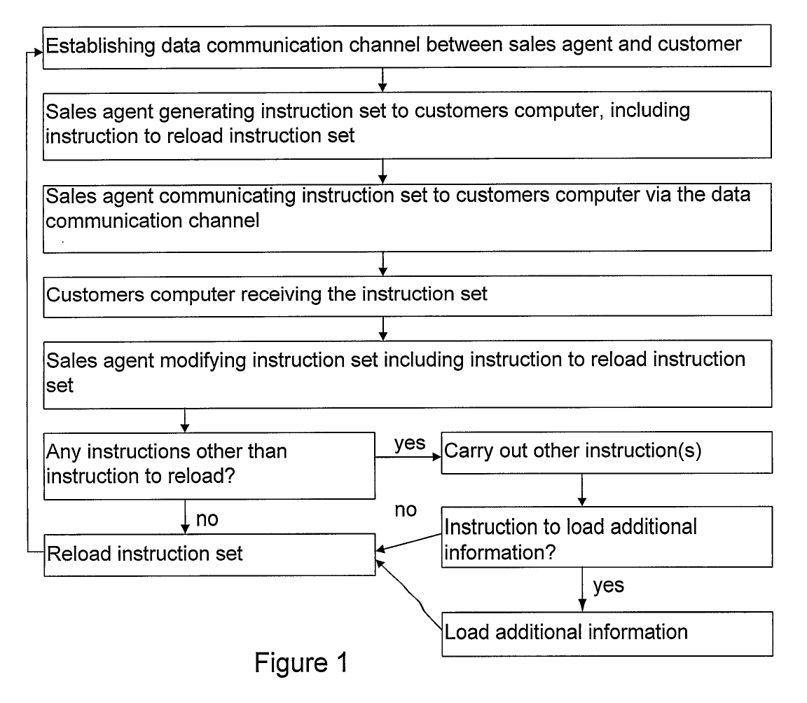

FIG. 1 is a flowchart illustrating the method of the present invention. At the beginning a data communication channel is established between a salesperson and a customer via a website. The salesperson then generates an instruction set to the customers computer. The instruction set comprises an instruction for the customers computer to reload the instruction set. The salesperson communicates the instruction set to the customers computer, and the customers computer receives it.

After the customers computer has received the initial instruction set the salesperson modifies the instruction set. The modified instruction set always comprises an instruction to reload the instruction set. Additionally the modified instruction set may comprise one or more other instructions relating to changes which have happened at the salesperson's computer and which require changes in the customer's computer. This has already been described above.

When the customers computer receives the instruction set, it investigates whether or not the instruction set comprises any instructions other than the reload instruction. If this is the case, this instruction/these instructions is/are carried out. In any event the reload instruction is carried out, causing a reload of the instruction set. Accordingly the loop is pointed back to the step of the customers computer receiving the instruction set, thereby creating an endless loop. The reloaded instruction set is the modified instruction set. The endless loop can only be terminated by an active act performed by either the salesperson or the customer.

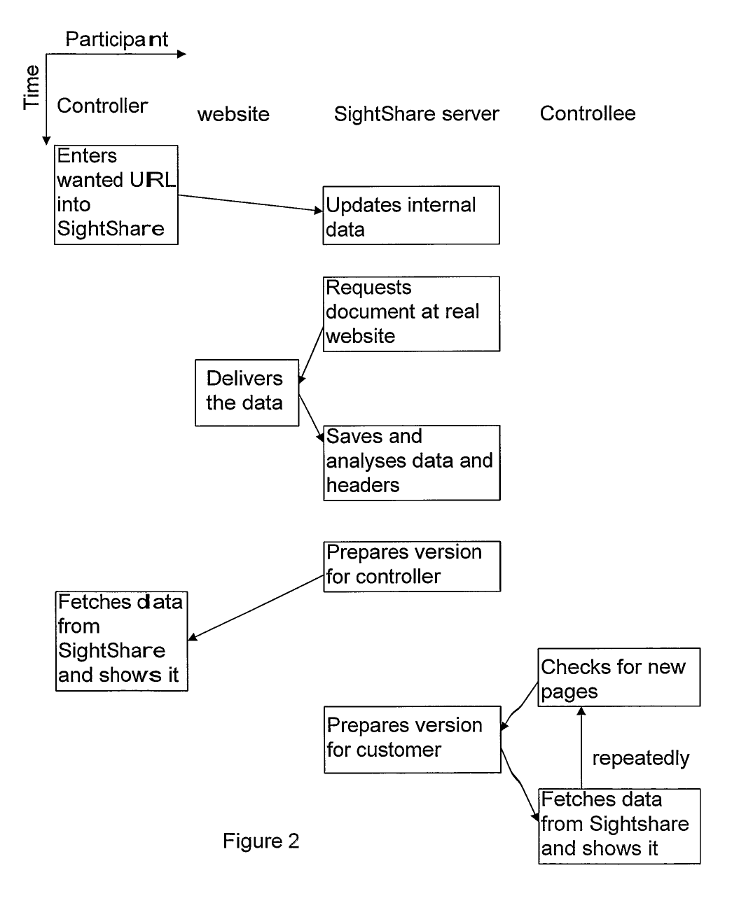

FIG. 2 is a flowchart illustrating how a specific website may be presented by a controller to a controlee during a session as described above. The controller is the person controlling the session and presenting information to the controlee. In one embodiment the controller is a salesperson and the controlee is a potential customer. Alternatively, the controller may be a teacher or lecturer and the controlee may be a student. The controller is preferably a person using the first computer, while the controlee is a person using the second computer. However, the roles of these two persons may switch during a session, e.g. on the request of the controller.

The controller enters the desired address of the website (URL) in a server connected to the controller's computer. The server then selects a unique sub domain at the server, and updates internal data to indicate that this sub domain is now equivalent to the selected URL.

The server then requests documents at the real website. The request is performed in such a way that the real website does not notice that it comes from the server, but thinks that the request is coming directly from the controller. In response to the request the website delivers the requested data to the server. The server in return saves and analyses the data and the headers of the received documents. On the basis of the analysis the server prepares a version of the website for the controller. This preparation may include changes to the headers and/or the document itself. The prepared version is presented to the controller.

The server also prepares a version of the website to the controlee. The controlee version is preferably prepared in such a manner that any active link present in the original website is removed or replaced by an identification code as described above. Thereby it is ensured that the controlee can not activate such links (at least not directly) and thereby control the session or even leave it. As described above, the controlee is continuously reloading the instruction set. When the version of the website is ready for the controlee, the instruction set is modified to include an instruction to request the controlee version from the server. When this instruction is received by the controlee, it is carried out, i.e. the controlee version is requested, received, and presented to the controlee.

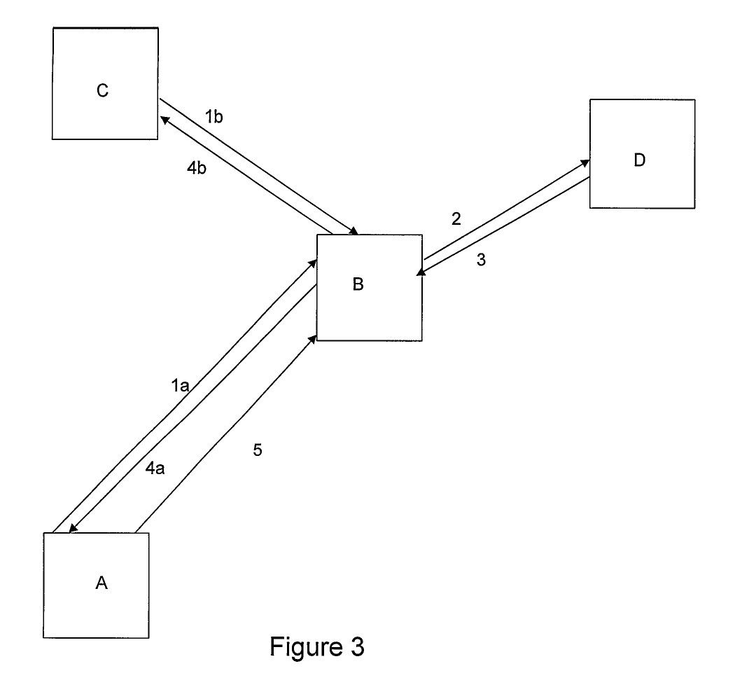

The feedback of the information from the customer as to how he/she navigates may be seen in FIG. 3. Normally, when one browses a website, the selecting or activation of a link thereon returns information to the website of a new page to provide to the user.

This information to return is provided in the page actually browsed and in the link.

This link may be replaced with information to the controllee, so that the controllee can se, which link is desired activated.

In FIG. 3, 4 computers are seen: the computers A and C, one of which is that of the controllee and the other that of the customer, B is a controlling server, and D is the 3^{rd} party website browsed.

Initially (step 1a), the ID of the website is transmitted to the server B, which instructs the website (step 2) to transmit a page (step 3), which is then transmitted to the computer A in one version (step 4a) and to computer B in another version (step 4b). These versions may be different in that the version 4a may comprise the correct links and the version 4b may have these removed (or vice versa).

Now, the computer A desires another link activated. This information is transmitted to the server B as step 5, whereby the same actions are repeated.

When the computer A is controlled by the customer, the server B will remove the actual links on the pages received in step 3 and forward the pages 4a with such links replaced with information (received in step 5) which is interpreted accordingly, whereafter the server B is able to forward the correct links to the website D. In this situation, the computer C is merely monitoring the actions of the computer A.

Contrary to that, the computer C may be that of the customer, and the controller may operate the computer A and thereby actively browse the website D. In this manner, the versions 4a may be those with the actual links, and the versions 4b transmitted to the customer may have the links removed or replaced. Now, the customer is monitoring or viewing the controllers browsing of the website D in a manner so that he/she cannot interfere therewith.

The prepared versions of the website are deleted from the server when they are no longer needed, e.g. after a specified time has elapsed, such 24 hours.

1-9. (canceled)

10. A method for communicating data via a computer network, the method comprising the steps of:
a. establishing a data communication channel between a first computer and a second computer,
b. the first computer generating an instruction set, said instruction set comprising an instruction for the second computer to reload said instruction set when the instruction set has been received by the second computer,
c. the first computer communicating the instruction set to the second computer using the data communication channel,
d. the first computer modifying the instruction set, the modified instruction set comprising an instruction for the second computer to reload the instruction set when the instruction set has been received by the second computer,
e. the second computer carrying out the instructions of the instruction set, thereby receiving/reloading the modified instruction set, and
repeating steps d and e until the first and/or the second computer terminates the process, the method further comprising the steps of:
the first computer establishing a link to an external website,
the first computer creating a modified version of said external website,
wherein at least one of the instruction sets further comprises an instruction for the second computer to request the modified external website,
the second computer requesting the modified external website, and
the second computer downloading the modified external website.

11. A method according to claim 10, further comprising the step of the first computer preparing the further data.

12. A method according to claim 11, wherein the preparation of the further data is caused by one or more actions performed by a person using the first computer.

13. A method according to claim 10, wherein the step of creating a modified version of the external website comprises removing any active link present in the external website.

14. A method according to claim 10, wherein at least one of the instruction sets further comprises an instruction to perform one or more local actions at the second computer, the method further comprising the step of the second computer performing said one or more local actions.

15. A computer network comprising:
a first computer and a second computer, each being capable of establishing a data communication channel, so as to create a data communication channel between said first computer and said second computer,
means for generating an instruction set in the first computer, said instruction set comprising an instruction for the second computer to reload said instruction set when the instruction set has been received by the second computer,
means for communicating the instruction set to the second computer using the communication channel,
means for modifying the instruction set in the first computer, the modified instruction set comprising an instruction for the second computer to reload the instruction set when the instruction set has been received by the second computer,
means for carrying out the instructions of the instruction set by the second computer, and
means for terminating the process on the occasion of the first and/or the second computer, wherein at least one of the instruction sets further comprises an instruction for the second computer to request further data and/or information from the first computer, a website and/or from a third computer,
the network further comprising:
means for establishing a link between the first computer and an external website,
means for creating a modified version of said external website in the first computer,
means for generating an instruction set in the first computer, said instruction set comprising an instruction for the second computer to request the modified external website, and
means for downloading the modified external website to the second computer.

16. A computer network according to claim 15, wherein the first computer comprises means for preparing the further data.

17. A computer network according to claim 15, wherein the means for creating a modified version of the external website comprises means for removing any active link present in the external website.

18. A computer network according to claim 15, wherein at least one of the instruction sets further comprises an instruction to perform one or more local actions at the second computer, and wherein the second computer comprises means for performing said local actions.
